(19) United States
(12) Patent Application Publication
(10) Pub. No.: US 2008/0226102 A1
(43) Pub. Date: Sep. 18, 2008

(54) HEADPHONE WITH EXPANSION SPACE IN EITHER RECEIVER

(76) Inventor: Ching-chi Wang, Donnguan (CN)

Correspondence Address: SAM CHEN, 7F-1, 293, ROOSEVELT ROAD, SEC 3, TAIPEI, TW

(21) Appl. No.: 11/685,206

(22) Filed: Mar. 13, 2007

(51) Int. Cl. H04R 5/02

(52) U.S. Cl. 381/309

(57) ABSTRACT

A headphone includes left and right receivers each including an elongate shell including a peg projecting inwardly from either end; a housing shaped to conform to the shell and including a peripheral wall, a slot in either end, the slot adapted to securely engage with the peg, a first receiving space at one portion, a second receiving space at the other portion in communication with the first receiving space, and a plurality of bottom holes; a speaker mounted in the first receiving space; a plurality of buttons including a volume button mounted on a bottom of the second receiving space; and a cap fitted on the second receiving space; a band having both ends secured to the caps; and a swivel microphone secured to an outer surface of either receiver. Additional components (e.g., battery) can be mounted in the second receiving space.

### BACKGROUND OF THE INVENTION

1. Field of Invention

The invention relates to headphones and more particularly to such a headphone having an expansion space in either receiver for incorporating additional components.

2. Description of Related Art

Headphones are well known devices. Recently, a headphone can be attached to an MP3 player or ipod. One type of headphone is earbud which is a small headphone that is placed directly outside of the ear canal. However, a sufficiently high volume level made by using an earbud can cause temporary or permanent hearing impairment or deafness due to an effect called “masking.”

Another type of headphone is a relatively large headphone having a band or bands over the top of the head.

Typically, receiver space is crowded with required components. Thus, no space is available for mounting additional components in the receiver for expansion purposes. As a result, the conventional headphones do not have any expansion capabilities.

Still, there have been numerous suggestions in prior patents for headphone. For example, U.S. Pat. No. 6,252,970 discloses a headphone. Thus, continuing improvements in the exploitation of headphone are constantly being sought.

### SUMMARY OF THE INVENTION

It is therefore one object of the invention to provide a headphone having an expansion space in either receiver for incorporating additional components (e.g., a battery).

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of headphone according to the invention; and

FIG. 2 is a sectional view of the assembled headphone.

### DETAILED DESCRIPTION OF THE INVENTION

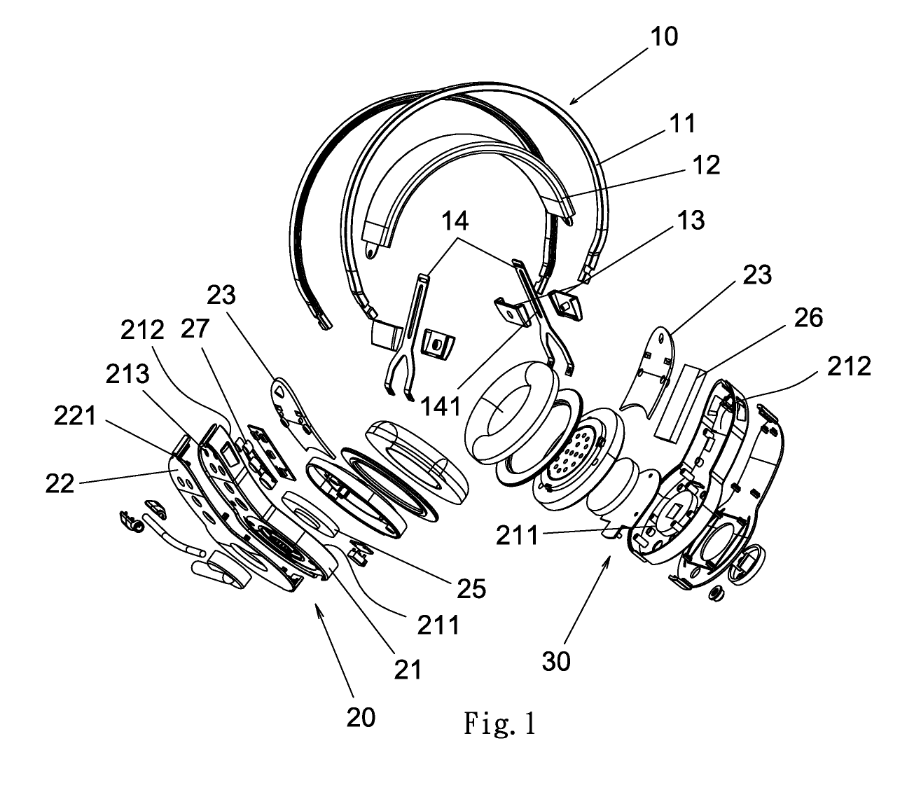

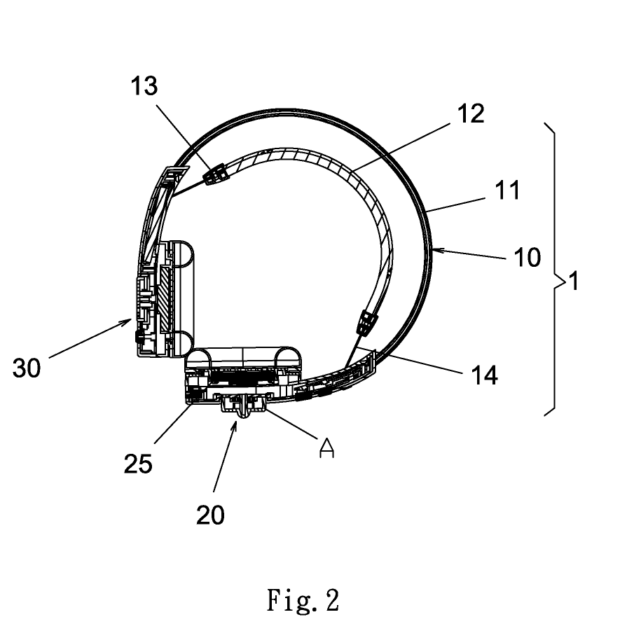

Referring to FIGS. 1 and 2, a headphone 1 in accordance with a preferred embodiment of the invention comprises a band 10, a left receiver 20, and a right receiver 30. Each component is discussed in detailed below.

The band 10 is adapted to put over a user's head and comprises two spaced, first curved members 11; a second curved member 12 shorter than the first curved member 11 and disposed between the first curved members 11; two Y-shaped connectors 14 including an elongate groove 141 along a main portion and a bifurcation (not numbered); and two pair of fasteners 13. Either end of the second curved member 12 can be disposed in any position of the groove 141 by sliding the connector 14 relative to the second curved member 12. Thereafter, each pair of fasteners 13 is adapted to releasably fasten either end of the second curved member 12 and the groove 141 together. This adjustable positioning of the connector 14 with respect to the second curved member 12 aims at fitting different individuals with various head sizes.

The left receiver 20 comprises an elongate shell 22 including a peg 221 projecting inwardly from either end; a housing 21 shaped to conform to the shell 22 and including a peripheral wall (not numbered), a slot (not numbered) in either end, the slot adapted to securely engage with the peg 221, an oval first receiving space 211 at one portion for mounting components (e.g., a speaker 25 and the like), an elongate second receiving space 212 at the other portion in communication with the first receiving space 211, and a plurality of bottom holes 213 for mounting a plurality of buttons (e.g., volume button 27 and the like); and a cap 23 fitted on the second receiving space 212 and secured to two open ends of the bifurcation of the connector 14.

A battery 26 (e.g., lithium cell or the like) can be mounted in the second receiving space 212. The battery 26 is adapted to supply power to a Bluetooth device for wireless networking. Hence, the headphone 1 can have the features of wire and wireless devices.

Note that the right receiver 30 is generally identical to the left receiver 20 described above except it is a mirror image thereof. Accordingly, further description is omitted for purposes of brevity and convenience only, and is not limiting.

Moreover, a swivel microphone A can be joined to an outer surface of the shell 22.

While the invention herein disclosed has been described by means of specific embodiments, numerous modifications and variations could be made thereto by those skilled in the art without departing from the scope and spirit of the invention set forth in the claims.

What is claimed is:

1. A headphone comprising:
left and right receivers each including an elongate shell including a peg projecting inwardly from either end; a housing shaped to conform to the shell and including a peripheral wall, a slot in either end, the slot adapted to securely engage with the peg, a first receiving space at one portion, a second receiving space at the other portion in communication with the first receiving space, and a plurality of bottom holes; a speaker mounted in the first receiving space; a plurality of buttons including a volume button mounted on a bottom of the second receiving space; and a cap fitted on the second receiving space;
a band having both ends secured to the caps; and
a swivel microphone secured to an outer surface of either receiver,
wherein a battery is adapted to mount in the second receiving space.

2. The headphone of claim 1, wherein the band comprises:
two spaced, first curved members;
a second curved member shorter than the first curved member and disposed between the first curved members;
two connectors including an elongate groove and a bifurcation; and
two pair of fasteners,
wherein either end of the second curved member is adapted to dispose in one of a plurality of positions of the groove by sliding the connector relative to the second curved member, and each pair of fasteners is adapted to releasably fasten either end of the second curved member and the groove together.
